(19) United States
(12) Patent Application Publication
(10) Pub. No.: US 2020/0374558 A1
(43) Pub. Date: Nov. 26, 2020

(54) IMAGE DECODING METHOD AND DEVICE USING ROTATION PARAMETERS IN IMAGE CODING SYSTEM FOR 360-DEGREE VIDEO

(71) Applicant: LG ELECTRONICS INC., Seoul (KR)

(72) Inventors: Ling LI, Seoul (KR); Jaehyun LIM, Seoul (KR)

(21) Appl. No.: 16/758,732

(22) PCT Filed: Jul. 4, 2018
(86) PCT No.: PCT/KR2018/007544

§ 371 Date: Apr. 23, 2020

Related U.S. Application Data
(60) Provisional application No. 62/575,527, filed on Oct. 23, 2017.

(51) Int. Cl. H04N 19/597; H04N 19/46; H04N 19/159; H04N 19/169; H04N 19/172

(52) U.S. Cl. CPC H04N 19/597; H04N 19/46; H04N 19/172; H04N 19/1883; H04N 19/159

(57) ABSTRACT

An image encoding method performed by an encoding device, according to the present invention, comprises the steps of: acquiring information associated with a 360-degree image in a 3D space; deriving rotation parameters for the 360-degree image; acquiring a projected picture by processing the 360-degree image on the basis of the rotation parameters for the 360-degree image, and a projection type; and generating, encoding and outputting 360-degree video information for the projected picture, wherein the projection type is equirectangular projection (ERP), and the 360-degree image in the 3D space is projected so that the specific position thereof in the 3D space, derived on the basis of the rotation parameters, is mapped at the center of the projected picture.

### CROSS-REFERENCE TO RELATED APPLICATIONS

This application is the National Stage filing under 35 U.S.C. 371 of International Application No. PCT/KR2018/007544, filed on Jul. 4, 2018, which claims the benefit of U.S. Provisional Application No. 62/575,527 filed on Oct. 23, 2017, the contents of which are all hereby incorporated by reference herein in their entirety.

### BACKGROUND OF THE DISCLOSURE

### Field of the disclosure

The present disclosure relates to 360-degree video, and more particularly, to an image decoding method and device using rotation parameters in a coding system for a 360-degree video.

### Related Art

A 360-degree video may imply video or image content required to provide a virtual reality (VR) system and captured or reproduced simultaneously in all directions (360 degrees). For example, the 360-degree video may be represented on a 3-dimensional spherical surface. The 360-degree video may be provided through a process of capturing an image or video for each of a plurality of time points through one or more cameras, connecting the captured plurality of images/videos to create one panoramic image/video or spherical image/video and projecting it on a 2D picture, and coding and transmitting the projected picture.

An amount of information or bits to be transmitted is relatively increased in the 360-degree video, compared to the conventional image data. Therefore, if the image data is transmitted by using a medium such as the conventional wired/wireless broadband line or if the image data is stored by using the conventional storage medium, transmission cost and storage cost are increased.

Accordingly, there is a need for a highly efficient image compression technique for effectively transmitting, storing, and reproducing 360-degree video information.

### SUMMARY

The present disclosure provides a method and apparatus for increasing efficiency of 360-degree video information transmission for providing a 360-degree video.

The present disclosure further provides a method and device for deriving rotation parameters related to a 360-degree video and projecting/re-projecting based on the rotation parameters.

The present disclosure further provides a method and device for minimizing a region in which discontinuity of a projected picture is generated based on rotation parameters.

In an aspect, a method of encoding a 360-degree image performed by an encoding device is provided. The method includes obtaining information about a 360-degree image on a 3D space; deriving rotation parameters of the 360-degree image; obtaining a projected picture by processing the 360-degree image based on the rotation parameters and a projection type of the 360-degree image; and generating, encoding, and outputting 360-degree video information of the projected picture, wherein the projection type is an equirectangular projection (ERP), and the 360-degree image on the 3D space is projected so that a specific position on the 3D space derived based on the rotation parameters is mapped to the center of the projected picture.

In another aspect, an encoding device for encoding a 360-degree image is provided. The encoding device includes a projection processor configured to obtain a 360-degree image on a 3D space, to derive rotation parameters of the 360-degree image, and to obtain a projected picture by processing the 360-degree image based on the rotation parameters and a projection type of the 360-degree image on the 3D space and an entropy encoder configured to generate, encode, and output 360-degree video information of the projected picture, wherein the projection type is an equirectangular projection (ERP), and the 360-degree vide data on the 3D space is projected so that a specific position on the 3D space derived based on the rotation parameters is mapped to the center of the projected picture.

In another aspect, a method of decoding a 360-degree image performed by a decoding device is provided. The method includes receiving 360-degree video information; deriving a projection type of a projected picture based on the 360-degree video information; deriving rotation parameters based on the 360-degree video information; and re-projecting a 360-degree image of the projected picture onto a 3D space based on the projection type and the rotation parameters, wherein the projection type is an equirectangular projection (ERP), and the 360-degree image of the projected picture is re-projected so that the center of the projected picture is mapped to a specific position on the 3D space derived based on the rotation parameters.

In another aspect, a decoding device for decoding a 360-degree image is provided. The decoding device includes an entropy decoder configured to receive 360-degree video information, to derive a projection type of a projected picture based on the 360-degree video information, and to derive rotation parameters based on the 360-degree video information; and a re-projection processor configured to re-project a 360-degree image of the projected picture onto a 3D space based on the projection type and the rotation parameters, wherein the projection type is an equirectangular projection (ERP), and the 360-degree image of the projected picture is re-projected so that the center of the projected picture is mapped to a specific position on the 3D space derived based on the rotation parameters.

### Advantageous Effects

According to the present disclosure, by projecting a rotated 360-degree image based on rotation parameters, a projected picture can be derived in which a region with a lot of motion information is positioned at the center and in which a region with little motion information is positioned at the bottom center and thus occurrence of artifacts by discontinuity of the projected pictures can be reduced, and overall coding efficiency can be improved.

According to the present disclosure, by projecting a rotated 360-degree image based on rotation parameters, a projected picture can be derived in which a region with a lot of motion information is positioned at the center and in which a region with little motion information is positioned at the bottom center and thus distortion of a moving object can be reduced and overall coding efficiency can be improved.

### BRIEF DESCRIPTION OF THE DRAWINGS

FIG. 1 is a view illustrating overall architecture for providing a 360-degree video according to the present disclosure.

FIG. 2 exemplarily illustrates a process of 360-degree video processing in an encoding device and a decoding device.

FIG. 3 briefly illustrates a structure of a video encoding device to which the present disclosure is applicable.

FIG. 4 briefly illustrates a structure of a video decoding device to which the present disclosure is applicable.

FIG. 5 exemplarily illustrates a projected picture derived based on the ERP.

FIG. 6 illustrates an example of a spherical coordinate system in which 360-degree video data is represented into a spherical surface.

FIG. 7 is a diagram illustrating the concept of aircraft principal axes for describing a spherical surface representing a 360-degree video.

FIG. 8 illustrates a projected picture derived based on an ERP for projecting rotated 360-degree video data onto the 2D picture.

FIG. 9 illustrates a projected picture so that a specific position is mapped to a center point of a projected picture.

FIG. 10 schematically illustrates a video encoding method by an encoding device according to the present disclosure.

FIG. 11 schematically illustrates a video decoding method by a decoding device according to the present disclosure.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments, but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the disclosure without departing from the concept of the disclosure.

Hereinafter, embodiments of the present disclosure will be described in detail with reference to the accompanying drawings. In addition, like reference numerals are used to indicate like elements throughout the drawings, and the same descriptions on the like elements will be omitted.

In the present disclosure, generally a picture means a unit representing an image at a specific time, a slice is a unit constituting a part of the picture. One picture may be composed of plural slices, and the terms of a picture and a slice may be mixed with each other as occasion demands

A pixel or a pel may mean a minimum unit constituting one picture (or image). Further, a “sample” may be used as a term corresponding to a pixel. The sample may generally represent a pixel or a value of a pixel, may represent only a pixel (a pixel value) of a luma component, and may represent only a pixel (a pixel value) of a chroma component.

A unit indicates a basic unit of image processing. The unit may include at least one of a specific area and information related to the area. Optionally, the unit may be mixed with terms such as a block, an area, or the like. In a typical case, an M×N block may represent a set of samples or transform coefficients arranged in M columns and N rows.

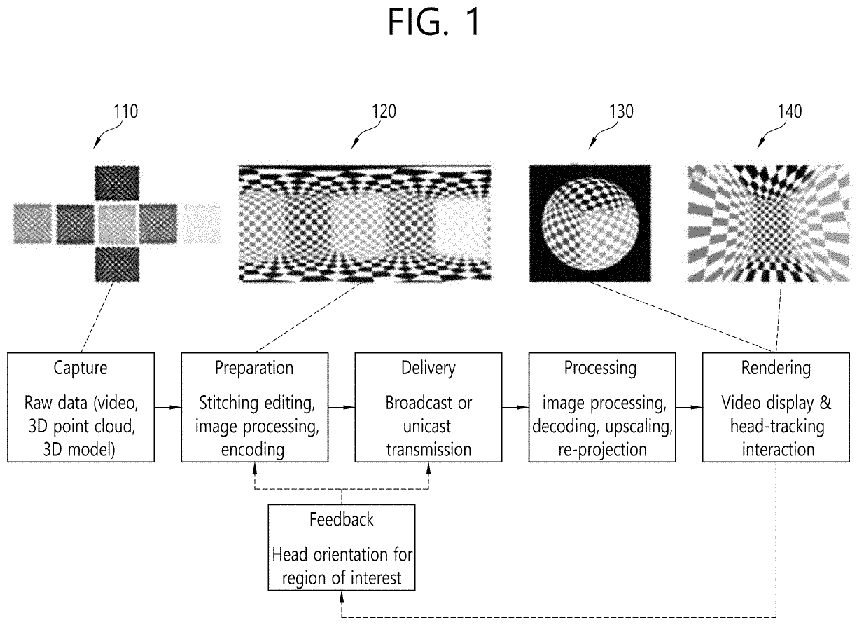

FIG. 1 is a view illustrating overall architecture for providing a 360-degree video according to the present disclosure.

The present disclosure proposes a method of providing 360-degree content in order to provide virtual reality (VR) to users. VR may refer to technology for replicating actual or virtual environments or those environments. VR artificially provides sensory experience to users and thus users can experience electronically projected environments.

360 content refers to content for realizing and providing VR and may include a 360-degree video and/or 360-degree audio. The 360-degree video may refer to video or image content which is necessary to provide VR and is captured or reproduced omnidirectionally (360 degrees). Hereinafter, the 360-degree video may refer to 360-degree video. A 360-degree video may refer to a video or an image represented on 3D spaces in various forms according to 3D models. For example, a 360-degree video can be represented on a spherical surface. The 360-degree audio is audio content for providing VR and may refer to spatial audio content whose audio generation source can be recognized to be located in a specific 3D space. 360 content may be generated, processed and transmitted to users and users can consume VR experiences using the 360 content.

Particularly, the present disclosure proposes a method for effectively providing a 360-degree video. To provide a 360-degree video, a 360-degree video may be captured through one or more cameras. The captured 360-degree video may be transmitted through series of processes and a reception side may process the transmitted 360-degree video into the original 360-degree video and render the 360-degree video. In this manner the 360-degree video can be provided to a user.

Specifically, processes for providing a 360-degree video may include a capture process, a preparation process, a transmission process, a processing process, a rendering process and/or a feedback process.

The capture process may refer to a process of capturing images or videos for a plurality of viewpoints through one or more cameras. Image/video data 110 shown in FIG. 1 may be generated through the capture process. Each plane of 110 in FIG. 1 may represent an image/video for each viewpoint. A plurality of captured images/videos may be referred to as raw data. Metadata related to capture can be generated during the capture process.

For capture, a special camera may be used. When a 360-degree video with respect to a virtual space generated by a computer is provided according to an embodiment, capture through an actual camera may not be performed. In this case, a process of simply generating related data can substitute for the capture process.

The preparation process may be a process of processing captured images/videos and metadata generated in the capture process. Captured images/videos may be subjected to a stitching process, a projection process, a region-wise packing process and/or an encoding process during the preparation process.

First, each image/video may be subjected to the stitching process. The stitching process may be a process of connecting captured images/videos to generate one panorama image/video or spherical image/video.

Subsequently, stitched images/videos may be subjected to the projection process. In the projection process, the stitched images/videos may be projected on 2D image. The 2D image may be called a 2D image frame or a projected picture according to context. Projection on a 2D image may be referred to as mapping to a 2D image. Projected image/video data may have the form of a 2D image 120 in FIG. 1.

Further, in a projection process, a process of dividing and processing video data projected onto a 2D image on a region basis may be applied. Here, the region may mean an area in which a 2D image is divided in which 360-degree video data is projected. Here, the 360-degree video data may be represented as a 360-degree image, and the region may correspond to a face or a tile. According to an embodiment, these regions may be divided by equally dividing or arbitrarily dividing a 2D image. Further, according to an embodiment, regions may be divided according to a projection scheme.

The processing process may include a process of rotating regions or rearranging the regions on a 2D image in order to improve video coding efficiency according to an embodiment. For example, it is possible to rotate regions such that specific sides of regions are positioned in proximity to each other to improve coding efficiency.

The processing process may include a process of increasing or decreasing resolution for a specific region in order to differentiate resolutions for regions of a 360-degree video according to an embodiment. For example, it is possible to increase the resolution of regions corresponding to relatively more important regions in a 360-degree video to be higher than the resolution of other regions. Video data projected on the 2D image may be subjected to the encoding process through a video codec.

According to an embodiment, the preparation process may further include an additional editing process. In this editing process, editing of image/video data before and after projection may be performed. In the preparation process, metadata regarding stitching/projection/encoding/editing may also be generated. Further, metadata regarding an initial viewpoint or a region of interest (ROI) of video data projected on the 2D image may be generated.

The transmission process may be a process of processing and transmitting image/video data and metadata which have passed through the preparation process. Processing according to an arbitrary transmission protocol may be performed for transmission. Data which has been processed for transmission may be delivered through a broadcast network and/or a broadband. Such data may be delivered to a reception side in an on-demand manner. The reception side may receive the data through various paths.

The processing process may refer to a process of decoding received data and re-projecting projected image/video data on a 3D model. In this process, image/video data projected on the 2D image may be re-projected on a 3D space. This process may be called mapping or projection according to context. Here, 3D model to which image/video data is mapped may have different forms according to 3D models. For example, 3D models may include a sphere, a cube, a cylinder and a pyramid.

According to an embodiment, the processing process may additionally include an editing process and an up-scaling process. In the editing process, editing of image/video data before and after re-projection may be further performed. When the image/video data has been reduced, the size of the image/video data can be increased by up-scaling samples in the up-scaling process. An operation of decreasing the size through down-scaling may be performed as necessary.

The rendering process may refer to a process of rendering and displaying the image/video data re-projected on the 3D space. Re-projection and rendering may be combined and represented as rendering on a 3D model. An image/video re-projected on a 3D model (or rendered on a 3D model) may have a form 130 shown in FIG. 1. The form 130 shown in FIG. 1 corresponds to a case in which the image/video is re-projected on a 3D spherical model. A user can view a region of the rendered image/video through a VR display. Here, the region viewed by the user may have a form 140 shown in FIG. 1.

The feedback process may refer to a process of delivering various types of feedback information which can be acquired in a display process to a transmission side. Interactivity in consumption of a 360-degree video can be provided through the feedback process. According to an embodiment, head orientation information, viewport information representing a region currently viewed by a user, and the like can be delivered to a transmission side in the feedback process. According to an embodiment, a user may interact with an object realized in a VR environment. In this case, information about the interaction may be delivered to a transmission side or a service provider in the feedback process. According to an embodiment, the feedback process may not be performed.

The head orientation information may refer to information about the position, angle, motion and the like of the head of a user. Based on this information, information about a region in a 360-degree video which is currently viewed by the user, that is, viewport information, can be calculated.

The viewport information may be information about a region in a 360-degree video which is currently viewed by a user. Gaze analysis may be performed through the viewpoint information to check how the user consumes the 360-degree video, which region of the 360-degree video is gazed by the user, how long the region is gazed, and the like. Gaze analysis may be performed at a reception side and a result thereof may be delivered to a transmission side through a feedback channel A device such as a VR display may extract a viewport region based on the position/direction of the head of a user, information on a vertical or horizontal field of view (FOY) supported by the device, and the like.

According to an embodiment, the aforementioned feedback information may be consumed at a reception side as well as being transmitted to a transmission side. That is, decoding, re-projection and rendering at the reception side may be performed using the aforementioned feedback information. For example, only a 360-degree video with respect to a region currently viewed by the user may be preferentially decoded and rendered using the head orientation information and/or the viewport information.

Here, a viewport or a viewport region may refer to a region in a 360-degree video being viewed by a user. A viewpoint is a point in a 360-degree video being viewed by a user and may refer to a center point of a viewport region. That is, a viewport is a region having a viewpoint at the center thereof, and the size and the shape of the region can be determined by an FOV which will be described later.

In the above-described overall architecture for providing a 360-degree video, image/video data which is subjected to the capture/projection/encoding/transmission/decoding/re-projection/rendering processes may be referred to as 360-degree video data. The term “360-degree video data” may be used as the concept including metadata and signaling information related to such image/video data.

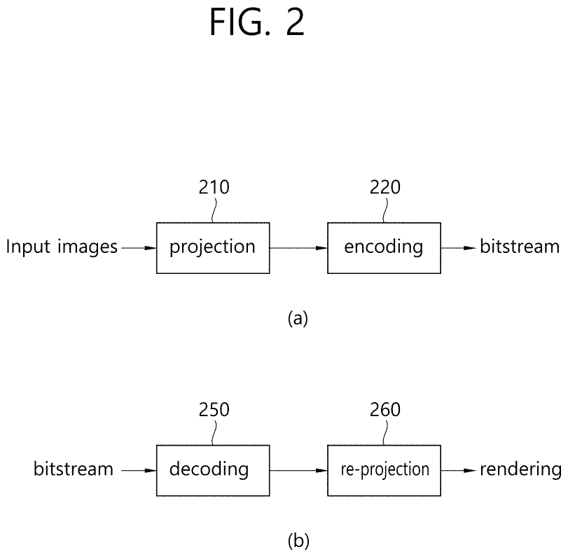

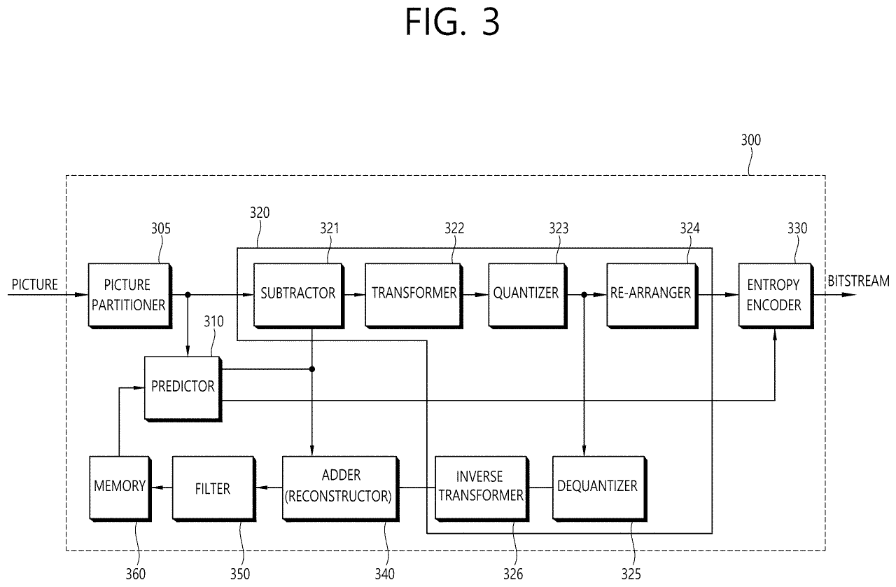

FIG. 2 exemplarily illustrates a process of 360-degree video processing in an encoding device and a decoding device. (a) of FIG. 2 may illustrate a process of input 360-degree video data processing performed by the encoding device. Referring to (a) of FIG. 2, a projection processor 210 may stitch and project the 360-degree video data at an input time on a 3D projection structure according to various projection schemes, and may show the 360-degree video data projected on the 3D projection structure as a 2D image. That is, the projection processor 210 may stitch the 360-degree video data, and may project the data on the 2D image. Herein, the projection scheme may be called a projection type. The 2D image on which the 360-video data is projected may be represented as a projected frame or a projected picture. The projected picture may be divided into a plurality of faces according to the projection type. The face may correspond to a tile. The plurality of faces of the projected picture may have the same size and shape (e.g., triangle or square) according to a specific projection type. In addition, the face in the projected picture may have a different size and shape according to the projection type. The projection processor 210 may perform a process of rotating or re-arranging each of regions of the projected picture or changing a resolution of each region. An encoding device 220 may encode information on the projected picture and may output it through a bitstream. A process of encoding the projected picture by the encoding device 220 will be described in detail with reference to FIG. 3. Meanwhile, the projection processor 210 may be included in the encoding device, or the projection process may be performed by means of an external device.

(b) of FIG. 2 may illustrate a process of processing information on a projected picture for 360-degree video data, performed by a decoding device. The information on the projected picture may be received through a bitstream.

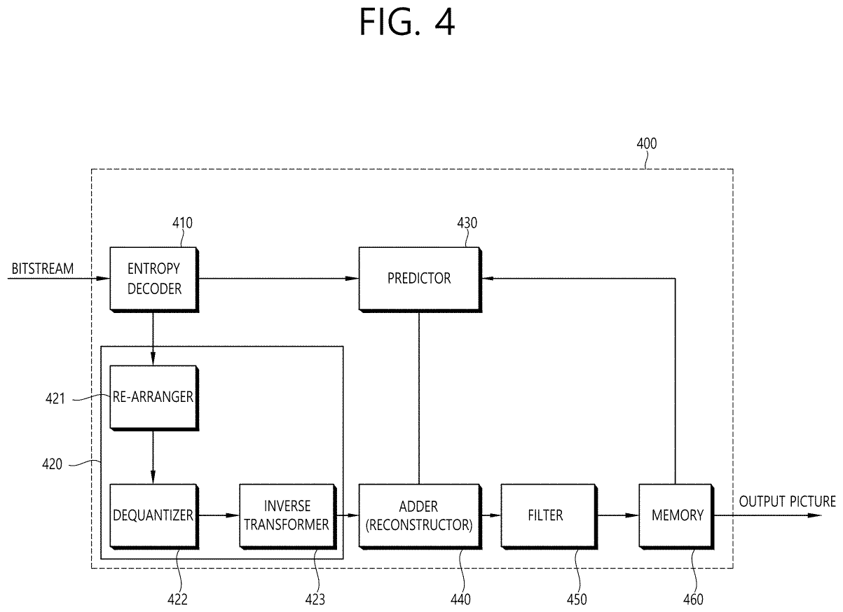

A decoding device 250 may decode the projected picture based on the received information on the projection picture. A process of decoding the projected picture by the decoding device 250 will be described in detail with reference to FIG. 4.

A re-projection processor 260 may re-project, on a 3D model, 360-degree video data on which the projected picture derived through the decoding process is projected. The re-projection processor 260 may correspond to the projection processor. In this process, the 360-degree video data projected on the projected picture may be re-projected on a 3D space. This process may be called mapping or projection according to context. The 3D space to be mapped in this case may have a different shape according to the 3D model. Examples of the 3D model may include sphere, cube, cylinder, or pyramid. Meanwhile, the re-projection processor 260 may be included in the decoding device 250, and the re-projection process may be performed by means of an external device. The re-projected 360-degree video data may be rendered on the 3D space.

FIG. 3 briefly illustrates a structure of a video encoding device to which the present disclosure is applicable.

Referring to FIG. 3, a video encoding device 300 may include a picture partitioner 305, a predictor 310, a residual processor 320, an entropy encoder 330, an adder 340, a filter 350, and a memory 360. The residual processor 320 may include a subtractor 321, a transformer 322, a quantizer 323, a re-arranger 324, a dequantizer 325, and an inverse transformer 326.

The picture partitioner 305 may split an input picture into at least one processing unit.

In an example, the processing unit may be referred to as a coding unit (CU). In this case, the coding unit may be recursively split from the largest coding unit (LCU) according to a quad-tree binary-tree (QTBT) structure. For example, one coding unit may be split into a plurality of coding units of a deeper depth based on a quadtree structure and/or a binary tree structure. In this case, for example, the quad tree structure may be first applied and the binary tree structure may be applied later. Alternatively, the binary tree structure may be applied first. The coding procedure according to the present disclosure may be performed based on a final coding unit which is not split any further. In this case, the largest coding unit may be used as the final coding unit based on coding efficiency, or the like, depending on image characteristics, or the coding unit may be recursively split into coding units of a lower depth as necessary and a coding unit having an optimal size may be used as the final coding unit. Here, the coding procedure may include a procedure such as prediction, transformation, and reconstruction, which will be described later.

In another example, the processing unit may include a coding unit (CU) prediction unit (PU), or a transform unit (TU). The coding unit may be split from the largest coding unit (LCU) into coding units of a deeper depth according to the quad tree structure. In this case, the largest coding unit may be directly used as the final coding unit based on the coding efficiency, or the like, depending on the image characteristics, or the coding unit may be recursively split into coding units of a deeper depth as necessary and a coding unit having an optimal size may be used as a final coding unit. When the smallest coding unit (SCU) is set, the coding unit may not be split into coding units smaller than the smallest coding unit. Here, the final coding unit refers to a coding unit which is partitioned or split to a prediction unit or a transform unit. The prediction unit is a unit which is partitioned from a coding unit, and may be a unit of sample prediction. Here, the prediction unit may be divided into sub-blocks. The transform unit may be divided from the coding unit according to the quad-tree structure and may be a unit for deriving a transform coefficient and/or a unit for deriving a residual signal from the transform coefficient. Hereinafter, the coding unit may be referred to as a coding block (CB), the prediction unit may be referred to as a prediction block (PB), and the transform unit may be referred to as a transform block (TB). The prediction block or prediction unit may refer to a specific area in the form of a block in a picture and include an array of prediction samples. Also, the transform block or transform unit may refer to a specific area in the form of a block in a picture and include the transform coefficient or an array of residual samples.

The predictor 310 may perform prediction on a processing target block (hereinafter, a current block), and may generate a predicted block including prediction samples for the current block. A unit of prediction performed in the predictor 310 may be a coding block, or may be a transform block, or may be a prediction block.

The predictor 310 may determine whether intra-prediction is applied or inter-prediction is applied to the current block. For example, the predictor 310 may determine whether the intra-prediction or the inter-prediction is applied in unit of CU.

In case of the intra-prediction, the predictor 310 may derive a prediction sample for the current block based on a reference sample outside the current block in a picture to which the current block belongs (hereinafter, a current picture). In this case, the predictor 310 may derive the prediction sample based on an average or interpolation of neighboring reference samples of the current block (case (i)), or may derive the prediction sample based on a reference sample existing in a specific (prediction) direction as to a prediction sample among the neighboring reference samples of the current block (case (ii)). The case (i) may be called a non-directional mode or a non-angular mode, and the case (ii) may be called a directional mode or an angular mode. In the intra-prediction, prediction modes may include as an example 33 directional modes and at least two non-directional modes. The non-directional modes may include DC mode and planar mode. The predictor 310 may determine the prediction mode to be applied to the current block by using the prediction mode applied to the neighboring block.

In case of the inter-prediction, the predictor 310 may derive the prediction sample for the current block based on a sample specified by a motion vector on a reference picture. The predictor 310 may derive the prediction sample for the current block by applying any one of a skip mode, a merge mode, and a motion vector prediction (MVP) mode. In case of the skip mode and the merge mode, the predictor 310 may use motion information of the neighboring block as motion information of the current block. In case of the skip mode, unlike in the merge mode, a difference (residual) between the prediction sample and an original sample is not transmitted. In case of the MVP mode, a motion vector of the neighboring block is used as a motion vector predictor and thus is used as a motion vector predictor of the current block to derive a motion vector of the current block.

In case of the inter-prediction, the neighboring block may include a spatial neighboring block existing in the current picture and a temporal neighboring block existing in the reference picture. The reference picture including the temporal neighboring block may also be called a collocated picture (colPic). Motion information may include the motion vector and a reference picture index. Information such as prediction mode information and motion information may be (entropy) encoded, and then output as a form of a bitstream.

When motion information of a temporal neighboring block is used in the skip mode and the merge mode, a highest picture in a reference picture list may be used as a reference picture. Reference pictures included in the reference picture list may be aligned based on a picture order count (POC) difference between a current picture and a corresponding reference picture. A POC corresponds to a display order and may be discriminated from a coding order.

The subtractor 321 generates a residual sample which is a difference between an original sample and a prediction sample. If the skip mode is applied, the residual sample may not be generated as described above.

The transformer 322 transforms residual samples in units of a transform block to generate a transform coefficient. The transformer 322 may perform transformation based on the size of a corresponding transform block and a prediction mode applied to a coding block or prediction block spatially overlapping with the transform block. For example, residual samples may be transformed using discrete sine transform (DST) transform kernel if intra-prediction is applied to the coding block or the prediction block overlapping with the transform block and the transform block is a 4×4 residual array and is transformed using discrete cosine transform (DCT) transform kernel in other cases.

The quantizer 323 may quantize the transform coefficients to generate quantized transform coefficients.

The re-arranger 324 rearranges quantized transform coefficients. The re-arranger 324 may rearrange the quantized transform coefficients in the form of a block into a one-dimensional vector through a coefficient scanning method. Although the re-arranger 324 is described as a separate component, the re-arranger 324 may be a part of the quantizer 323.

The entropy encoder 330 may perform entropy-encoding on the quantized transform coefficients. The entropy encoding may include an encoding method, for example, an exponential Golomb, a context-adaptive variable length coding (CAVLC), a context-adaptive binary arithmetic coding (CAB AC), or the like. The entropy encoder 330 may perform encoding together or separately on information (e.g., a syntax element value or the like) required for video reconstruction in addition to the quantized transform coefficients. The entropy-encoded information may be transmitted or stored in unit of a network abstraction layer (NAL) in a bitstream form.

The dequantizer 325 dequantizes values (transform coefficients) quantized by the quantizer 323 and the inverse transformer 326 inversely transforms values dequantized by the dequantizer 325 to generate a residual sample.

The adder 340 adds a residual sample to a prediction sample to reconstruct a picture. The residual sample may be added to the prediction sample in units of a block to generate a reconstructed block. Although the adder 340 is described as a separate component, the adder 340 may be a part of the predictor 310. Meanwhile, the adder 340 may be referred to as a reconstructor or reconstructed block generator.

The filter 350 may apply deblocking filtering and/or a sample adaptive offset to the reconstructed picture. Artifacts at a block boundary in the reconstructed picture or distortion in quantization may be corrected through deblocking filtering and/or sample adaptive offset. Sample adaptive offset may be applied in units of a sample after deblocking filtering is completed. The filter 350 may apply an adaptive loop filter (ALF) to the reconstructed picture. The ALF may be applied to the reconstructed picture to which deblocking filtering and/or sample adaptive offset has been applied.

The memory 360 may store a reconstructed picture (decoded picture) or information necessary for encoding/decoding. Here, the reconstructed picture may be the reconstructed picture filtered by the filter 350. The stored reconstructed picture may be used as a reference picture for (inter) prediction of other pictures. For example, the memory 360 may store (reference) pictures used for inter-prediction. Here, pictures used for inter-prediction may be designated according to a reference picture set or a reference picture list.

FIG. 4 briefly illustrates a structure of a video decoding device to which the present disclosure is applicable.

Referring to FIG. 4, a video decoding device 400 may include an entropy decoder 410, a residual processor 420, a predictor 430, an adder 440, a filter 450, and a memory 460. The residual processor 420 may include a re-arranger 421, a dequantizer 422, and an inverse transformer 423.

When a bitstream including video information is input, the video decoding device 400 may reconstruct a video in association with a process by which video information is processed in the video encoding device.

For example, the video decoding device 400 may perform video decoding using a processing unit applied in the video encoding device. Thus, the processing unit block of video decoding may be, for example, a coding unit and, in another example, a coding unit, a prediction unit or a transform unit. The coding unit may be split from the largest coding unit according to the quad tree structure and/or the binary tree structure.

A prediction unit and a transform unit may be further used in some cases, and in this case, the prediction block is a block derived or partitioned from the coding unit and may be a unit of sample prediction. Here, the prediction unit may be divided into sub-blocks. The transform unit may be split from the coding unit according to the quad tree structure and may be a unit that derives a transform coefficient or a unit that derives a residual signal from the transform coefficient.

The entropy decoder 410 may parse the bitstream to output information required for video reconstruction or picture reconstruction. For example, the entropy decoder 410 may decode information in the bitstream based on a coding method such as exponential Golomb encoding, CAVLC, CABAC, or the like, and may output a value of a syntax element required for video reconstruction and a quantized value of a transform coefficient regarding a residual. [85] More specifically, a CABAC entropy decoding method may receive a bin corresponding to each syntax element in a bitstream, determine a context model using decoding target syntax element information and decoding information of neighboring and decoding target blocks or information of symbol/bin decoded in a previous step, predict bin generation probability according to the determined context model and perform arithmetic decoding of the bin to generate a symbol corresponding to each syntax element value. Here, the CABAC entropy decoding method may update the context model using information of a symbol/bin decoded for a context model of the next symbol/bin after determination of the context model.

Information about prediction among information decoded in the entropy decoder 410 may be provided to the predictor 450 and residual values, that is, quantized transform coefficients, on which entropy decoding has been performed by the entropy decoder 410 may be input to the re-arranger 421.

The re-arranger 421 may rearrange the quantized transform coefficients into a two-dimensional block form. The re-arranger 421 may perform rearrangement corresponding to coefficient scanning performed by the encoding device. Although the re-arranger 421 is described as a separate component, the re-arranger 421 may be a part of the dequantizer 422.

The dequantizer 422 may de-quantize the quantized transform coefficients based on a (de)quantization parameter to output a transform coefficient. In this case, information for deriving a quantization parameter may be signaled from the encoding device.

The inverse transformer 423 may inverse-transform the transform coefficients to derive residual samples.

The predictor 430 may perform prediction on a current block, and may generate a predicted block including prediction samples for the current block. A unit of prediction performed in the predictor 430 may be a coding block or may be a transform block or may be a prediction block.

The predictor 430 may determine whether to apply intra-prediction or inter-prediction based on information on a prediction. In this case, a unit for determining which one will be used between the intra-prediction and the inter-prediction may be different from a unit for generating a prediction sample. In addition, a unit for generating the prediction sample may also be different in the inter-prediction and the intra-prediction. For example, which one will be applied between the inter-prediction and the intra-prediction may be determined in unit of CU. Further, for example, in the inter-prediction, the prediction sample may be generated by determining the prediction mode in unit of PU, and in the intra-prediction, the prediction sample may be generated in unit of TU by determining the prediction mode in unit of PU.

In case of the intra-prediction, the predictor 430 may derive a prediction sample for a current block based on a neighboring reference sample in a current picture. The predictor 430 may derive the prediction sample for the current block by applying a directional mode or a non-directional mode based on the neighboring reference sample of the current block. In this case, a prediction mode to be applied to the current block may be determined by using an intra-prediction mode of a neighboring block.

In the case of inter-prediction, the predictor 430 may derive a prediction sample for a current block based on a sample specified in a reference picture according to a motion vector. The predictor 430 may derive the prediction sample for the current block using one of the skip mode, the merge mode and the MVP mode. Here, motion information required for inter-prediction of the current block provided by the video encoding device, for example, a motion vector and information about a reference picture index may be acquired or derived based on the information about prediction.

In the skip mode and the merge mode, motion information of a neighboring block may be used as motion information of the current block. Here, the neighboring block may include a spatial neighboring block and a temporal neighboring block.

The predictor 430 may construct a merge candidate list using motion information of available neighboring blocks and use information indicated by a merge index on the merge candidate list as a motion vector of the current block. The merge index may be signaled by the encoding device. Motion information may include a motion vector and a reference picture. When motion information of a temporal neighboring block is used in the skip mode and the merge mode, a highest picture in a reference picture list may be used as a reference picture.

In the case of the skip mode, a difference (residual) between a prediction sample and an original sample is not transmitted, distinguished from the merge mode.

In the case of the MVP mode, the motion vector of the current block may be derived using a motion vector of a neighboring block as a motion vector predictor. Here, the neighboring block may include a spatial neighboring block and a temporal neighboring block.

When the merge mode is applied, for example, a merge candidate list may be generated using a motion vector of a reconstructed spatial neighboring block and/or a motion vector corresponding to a Col block which is a temporal neighboring block. A motion vector of a candidate block selected from the merge candidate list is used as the motion vector of the current block in the merge mode. The aforementioned information about prediction may include a merge index indicating a candidate block having the best motion vector selected from candidate blocks included in the merge candidate list. Here, the predictor 430 may derive the motion vector of the current block using the merge index.

When the Motion vector Prediction (MVP) mode is applied as another example, a motion vector predictor candidate list may be generated using a motion vector of a reconstructed spatial neighboring block and/or a motion vector corresponding to a Col block which is a temporal neighboring block. That is, the motion vector of the reconstructed spatial neighboring block and/or the motion vector corresponding to the Col block which is the temporal neighboring block may be used as motion vector candidates. The aforementioned information about prediction may include a prediction motion vector index indicating the best motion vector selected from motion vector candidates included in the list. Here, the predictor 430 may select a prediction motion vector of the current block from the motion vector candidates included in the motion vector candidate list using the motion vector index. The predictor of the encoding device may obtain a motion vector difference (MVD) between the motion vector of the current block and a motion vector predictor, encode the MVD and output the encoded MVD in the form of a bitstream. That is, the MVD may be obtained by subtracting the motion vector predictor from the motion vector of the current block. Here, the predictor 430 may acquire a motion vector included in the information about prediction and derive the motion vector of the current block by adding the motion vector difference to the motion vector predictor. In addition, the predictor may obtain or derive a reference picture index indicating a reference picture from the aforementioned information about prediction.

The adder 440 may add a residual sample to a prediction sample to reconstruct a current block or a current picture. The adder 440 may reconstruct the current picture by adding the residual sample to the prediction sample in units of a block. When the skip mode is applied, a residual is not transmitted and thus the prediction sample may become a reconstructed sample. Although the adder 440 is described as a separate component, the adder 440 may be a part of the predictor 430. Meanwhile, the adder 440 may be referred to as a reconstructor or reconstructed block generator.

The filter 450 may apply deblocking filtering, sample adaptive offset and/or ALF to the reconstructed picture. Here, sample adaptive offset may be applied in units of a sample after deblocking filtering. The ALF may be applied after deblocking filtering and/or application of sample adaptive offset.

The memory 460 may store a reconstructed picture (decoded picture) or information necessary for decoding. Here, the reconstructed picture may be the reconstructed picture filtered by the filter 450. For example, the memory 460 may store pictures used for inter-prediction. Here, the pictures used for inter-prediction may be designated according to a reference picture set or a reference picture list. A reconstructed picture may be used as a reference picture for other pictures. The memory 460 may output reconstructed pictures in an output order.

Unlike a picture of the existing 2D (dimension) image, a projected picture of a 3D video, which is a 3D image is a picture derived by projecting 360-degree video data on a 3D space onto a 2D image, and the projected picture may include discontinuity. In other words, unlike the existing 2D image, a 360-degree video, which is a 3D image is a continuous image on a 3D space, and when the 360-degree video is projected onto a 2D image, the continuous 360-degree video on the 3D space may be included in a discontinuous region in the projected picture. After an encoding/decoding process of the projected picture is performed, when a 360-degree video included in the discontinuous region in the projected picture is re-projected onto the 3D space, an encoding/decoding process is performed in a discontinuous state and thus artifacts appearing discontinuously on the 3D space may occur, unlike an original image. Accordingly, as the number of discontinuous regions is small, coding efficiency can be improved, and the present disclosure proposes a method of generating the small number of discontinuous regions in a process of projecting the 360-degree video onto the 2D image. A detailed description of a method of generating the small number of discontinuous regions will be described later.

The 360-degree video data on a 3D space may be projected onto 2D pictures into various projection types, and the projection types may be as follows.

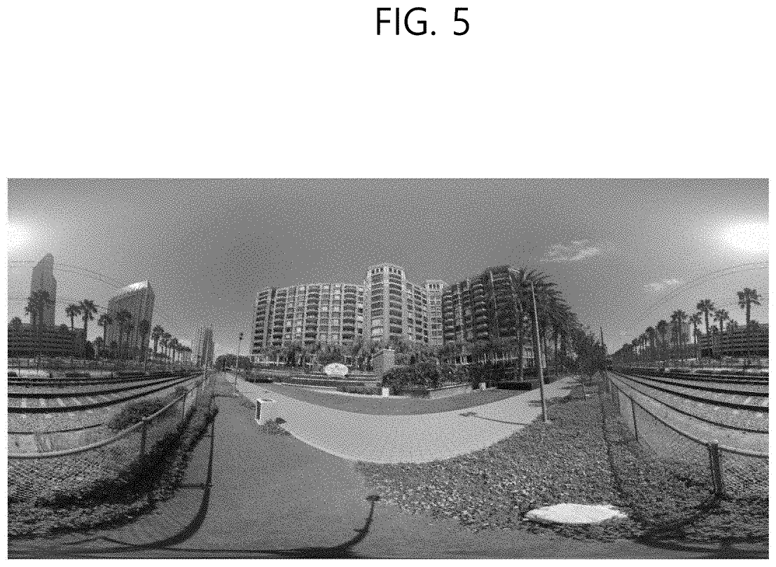

FIG. 5 exemplarily illustrates a projected picture derived based on the ERP. 360-degree video data may be projected on a 2D picture. Herein, the 2D picture on which the 360-degree video data is projected may be called a projected frame or a projected picture. The 360-degree video data may be projected on a picture through various projection types. For example, the 360-degree video data may be projected and/or packed on the picture through equirectangular projection (ERP), cube map projection(CMP), icosahedral projection (ISP), octahedron projection (OHP), truncated square pyramid projection (TSP), segmented sphere projection (SSP), or equal area projection (EAP). Specifically, stitched 360-degree video data may be represented on the 3D projection structure based on the projection type, that is, the 360-degree video data may be mapped on a face of the 3D projection structure of each projection type, and the face may be projected on the projected picture.

Referring to FIG. 5, the 360-degree video data may be projected on a 2D picture through ERP. When the 360-degree video data is projected through the ERP, for example, the stitched 360-degree data may be represented on a spherical surface, that is, the 360-degree video data may be mapped on the spherical surface, and may be projected as one picture of which continuity is maintained on the spherical surface. The 3D projection structure of the ERP may be a sphere having one face. Therefore, as shown in FIG. 5, the 360-degree video data may be mapped on one face in the projected picture.

In addition, for another example, the 360-degree video data may be projected through the CMP. The 3D projection structure of the CMP may be a cube. Therefore, when the 360-degree video data is projected through the CMP, the stitched 360-degree video data may be represented on the cube, and the 360-degree video data may be projected on the 2D image by being divided into a 3D projection structure of a hexahedral shape. That is, the 360-degree video data may be mapped on 6 faces of the cube, and the faces may be projected on the projected picture.

In addition, for another example, the 360-degree video data may be projected through the ISP. The 3D projection structure of the ISP may be an icosahedron. Therefore, when the 360-degree video data is projected through the ISP, the stitched 360-degree video data may be represented on the icosahedron, and the 360-degree video data may be projected on the 2D image by being divided into a 3D projection structure of an icosahedral shape. That is, the 360-degree video data may be mapped to 20 faces of the icosahedron, and the faces may be projected on the projected picture.

In addition, for another example, the 360-degree video data may be projected through the OHP. The 3D projection structure of the OHP may be an octahedron. Therefore, when the 360-degree video data is projected through the OHP, the stitched 360-degree video data may be represented on an octahedron, and the 360-degree video data may be projected on a 2D image by being divided into a 3D projection structure of an octahedron shape. That is, the 360-degree video data may be mapped on 8 faces of the octahedron, and the faces may be projected on the projected picture.

In addition, for another example, the 360-degree video data may be projected through the TSP. The 3D projection structure of the TSP may be a truncated square pyramid. Therefore, when the 360-degree video data is projected through the TSP, the stitched 360-degree video data may be represented on the truncated square pyramid, and the 360-degree video data may be projected on a 2D image by being divided into a 3D projection structure of the truncated square pyramid. That is, the 360-degree video data may be mapped on 6 faces of the truncated square pyramid, and the faces may be projected on the projected picture.

In addition, for another example, the 360-degree video data may be projected through the SSP. The 3D projection structure of the SSP may be a spherical surface having 6 faces. Specifically, the faces may include faces of two circular shapes for positive-pole regions and faces of four square block shapes for the remaining regions. Therefore, when the 360-degree video data is projected through the SSP, the stitched 360-degree video data may be represented on the spherical surface having 6 faces, and the 360-degree video data may be projected on a 2D image by being divided into a 3D projection structure of the spherical having 6 faces. That is, the 360-degree video data may be mapped to 6 faces of the spherical surface, and the faces may be projected on the projected picture.

In addition, for another example, the 360-degree video data may be projected through the EAP. The 3D projection structure of the EAP may be a sphere. Therefore, when the 360-degree video data is projected through the EAP, the stitched 360-degree video data may be represented on a spherical surface, that is, the 360-degree video data may be mapped on the spherical surface, and may be projected as one picture of which continuity is maintained on the spherical surface. That is, the 360-degree video data may be mapped to one face of the sphere, and the face may be projected on the projected picture. Herein, unlike the ERP, the EAP may represent a method in which a specific region of the spherical surface is projected on the projected picture with the same size as a size on the spherical surface.

When the 360-degree video data is projected through the ERP, for example, as illustrated in FIG. 5, a 3D space of the ERP, i.e., the 360-degree video data on a spherical surface may be mapped to one face in the projected picture, a center point on the spherical surface may be mapped to a center point of the projected picture, and be projected as one picture in which continuity on the spherical surface is maintained. Here, the center point on the spherical surface may be referred to as orientation on the spherical surface.

When the spherical surface, i.e., the 3D space is represented by a spherical coordinate system, the center point may mean a point of θ=0 and φ=0, and when the 3D space is represented by aircraft principle axes (yaw/pitch/roll coordinate system), it may mean a point of pitch=0, yaw=0, and roll=0. Here, the 3D space may be referred to as a projection structure or VR geometry.

The spherical coordinate system representing the 3D space and the aircraft principle axes (yaw/pitch/roll coordinate system) may be described later.

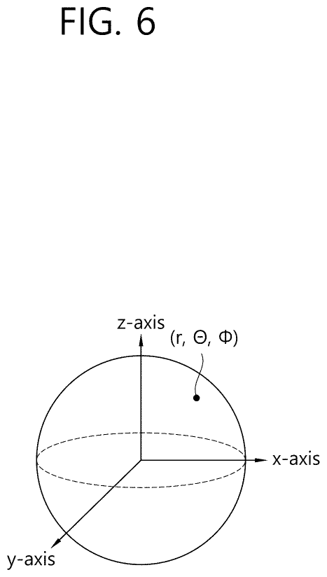

FIG. 6 illustrates an example of a spherical coordinate system in which 360-degree video data is represented into a spherical surface. 360-degree video data obtained by a camera may be represented by a spherical surface. As illustrated in FIG. 6, each point on the spherical surface may be represented through r (radius of a sphere), θ (rotation direction and degree based on the z axis), and φ (rotation direction and degree toward the z axis of the x-y plane) using a spherical coordinate system. According to an embodiment, the spherical surface may match to a world coordinate system, or a principal point of a front camera may be assumed to be a point (r, 0, 0) of the spherical surface.

A position of each point on the spherical surface may be represented based on aircraft principal axes. For example, a position of each point on the spherical surface may be represented through pitch, yaw, and roll.

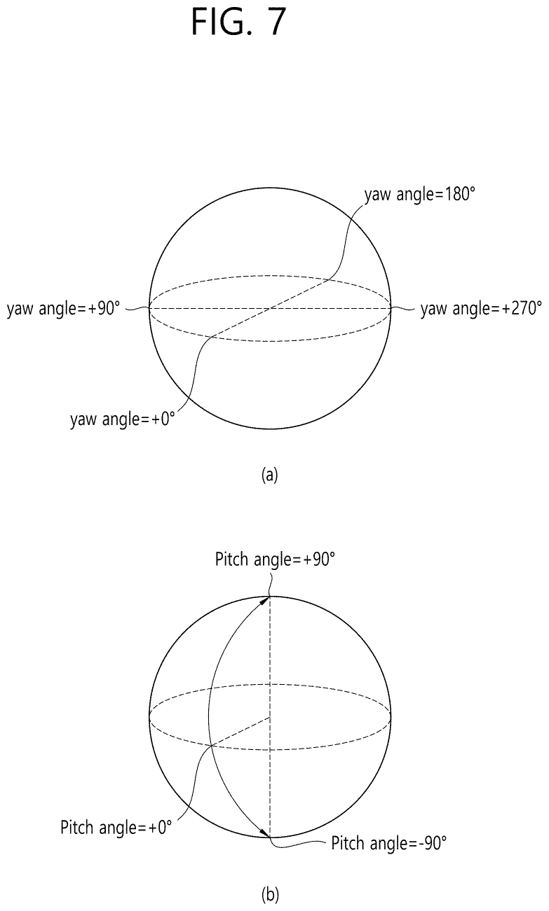

FIG. 7 is a diagram illustrating the concept of aircraft principal axes for describing a spherical surface representing a 360-degree video. In the present disclosure, the concept of aircraft principle axes may be used for representing a specific point, position, direction, spacing, area, etc. in a 3D space. That is, in the present disclosure, a 3D space before projection or after re-projection is described, and in order to perform signaling thereof, the concept of aircraft principle axes may be used. Specifically, a position of each point on the spherical surface may be represented based on the aircraft principal axes. The three-dimensional axes may be referred to as a pitch axis, a yaw axis, and a roll axis, respectively. In this disclosure, these may be represented as a pitch, yaw, and roll or a pitch direction, a yaw direction, and a roll direction. The position of each point on the spherical surface may be represented through pitch, yaw, and roll. Compared to the XYZ coordinate system, the pitch axis may correspond to the X axis, the yaw axis may correspond to the Z axis, and the roll axis may correspond to the Y axis.

Referring to FIG. 7(a), a yaw angle may represent a rotation direction and degree based on the yaw axis, and a range of the yaw angle may be from 0 degree to +360 degrees or from −180 degrees to +180 degrees. Further, referring to FIG. 7(b), a pitch angle may indicate a rotation direction and degree based on a pitch axis, and the range of the pitch angle may be 0 degree to +180 degrees or −90 degrees to +90 degrees. The roll angle may indicate a rotation direction and degree based on a roll axis, and the range of the roll angle may be 0 degree to +360 degrees or −180 degrees to +180 degrees. In the following description, the yaw angle may increase clockwise, and the range of the yaw angle may be assumed to be 0 degree 360 degrees. Further, the pitch angle may increase toward the North Pole, and the range of the North Pole angle may be assumed to be −90 degrees to +90 degrees.

As a method of generating the discontinuous regions to be less, a method of rotating 360-degree video data on the spherical surface and projecting the rotated 360-degree video data onto the 2D picture instead of a method of projecting a center point on the existing spherical surface to be mapped to a center point of the projected picture may be proposed. In other words, instead of mapping the center point on the spherical surface to the center point of the projected picture, while a position derived by rotating by a specific value at the center point on the spherical surface is mapped to the center point of the projected picture, a method of projecting onto a single picture in which continuity on the spherical surface is maintained may be proposed. The above-described method of rotating 360-degree video data on the spherical surface and projecting the rotated 360-degree video data onto the 2D picture may be referred to as a global rotation.

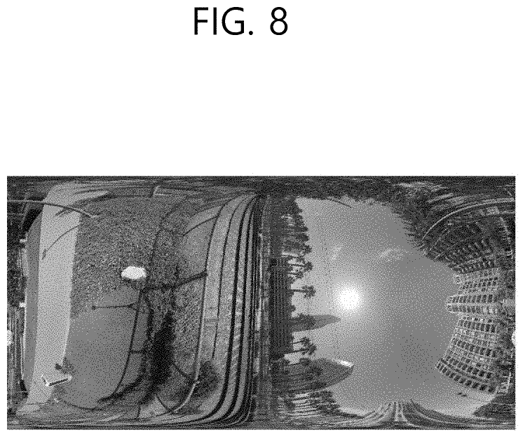

FIG. 8 illustrates a projected picture derived based on an ERP for projecting rotated 360-degree video data onto the 2D picture. When 360-degree video data is projected through the existing ERP, an object such as a building or a road may be distorted in a different shape, and the trajectory of a moving object may be changed, as illustrated in FIG. 5. Further, as illustrated in FIG. 5, continuous train rails on a spherical surface may be divided in half and be positioned at the left and right sides of the projected picture. In this case, an encoding/decoding process is performed in a discontinuous state, and artifacts appearing discontinuously on a re-projected 3D space may occur unlike an original image. Accordingly, in the present disclosure, a specific position is derived by rotating by a specific value at the center point on the spherical surface, and 360-degree video data on the spherical surface is projected as one picture in which continuity is maintained, but a method of projecting the specific position to be mapped to the center point of the projected picture may be proposed.

FIG. 8 may represent a projected picture so that the specific position is mapped to the center point of the projected picture. Referring to FIG. 8, the specific position may be derived as (180, 0, 90). In this case, unlike the existing projected picture illustrated in FIG. 5, a train rail may be positioned at the center of the projected picture in the projected picture so that a specific position is mapped to the center point of the projected picture. Through a method of projecting the specific position to be mapped to the center point of the projected picture, discontinuous portions may be generated to be less, and coding efficiency may be improved due to the difference.

Specifically, most 360-degree videos projected based on an ERP have features such as a small motion movement, compared to a whole static background screen. That is, the 360-degree video may include a static background screen and an object with a movement. Accordingly, when using a method of searing for appropriate rotation parameters and applying the rotation parameters to the entire 360-degree video prior to an encoding process, i.e., when a method of rotating the 360-degree video on a spherical surface by a specific value and projecting the 360-degree video onto a 2D picture so that a specific position, which is the center of the rotated 360-degree video is mapped to the center point of the projected picture, coding efficiency can be improved rather than projecting through the existing ERP. In particular, when positioning the specific object at the center of the projected picture so that a motion vector of a specific object having a motion in the projected picture is preserved, coding efficiency can be improved.

In the present disclosure, a method of automatically deriving the rotation parameters may be proposed instead of an exhaustive search for rotation parameters of the 360-degree video. The rotation parameters may be derived as a value that enables the specific object to be positioned at the center of the picture so that a motion vector of a specific object having a motion in the projected picture is preserved. A method of deriving the specific rotation parameters may be as follows.

First, the encoding/decoding device may calculate motion information about each CTU of non intra pictures among first group of pictures (GOP) of the 360-degree video. The motion information about the CTU may be derived as the sum of motion vectors of each CU included in the CTU. Alternatively, the motion information about the CTU may be derived as the number of CUs included in the CTU and in which inter prediction is performed or may be derived as the number of motion vectors of CUs included in each CTU.

Next, the encoding/decoding device may derive a CTU of the largest motion information among CTUs of the non-intra pictures as a CTUₘₐₓ and derive a CTU of the smallest motion information as a CTUₘᵢₙ. Thereafter, the encoding/decoding device may enable the CTUₘₐₓ to be positioned at the center of the picture and enable the CTUₘᵢₙ to be possibly positioned close to the center of the bottom of the picture. In this case, a specific value that enables the CTUₘₐₓ to be positioned at the center of the picture and enables the CTUₘᵢₙ to be possibly positioned close to the center of the bottom of the picture may be derived as rotation parameters of the 360-degree video. For example, when a position of each point on the spherical surface is represented based on the above-described aircraft principal axes, instead of being projected around the center point on the spherical surface, at a picture projected around a specific position moved by a specific pitch value, a specific yaw value, and a specific roll value, when the CTUₘₐₓ is positioned at the center of the picture, and when the CTUₘᵢₙ is possibly positioned close to the center of the bottom of the picture, the specific pitch value, the specific yaw value, and the specific roll value may be derived as rotation parameters of the 360-degree video. The size of the CTU may generally increase as the size of a picture increases.

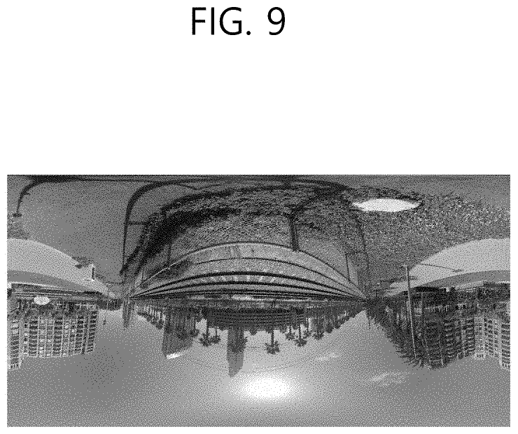

FIG. 9 illustrates a projected picture so that a specific position is mapped to a center point of a projected picture. Referring to FIG. 9, an area including a train rail of a projected picture may be positioned at the center of the projected picture, and an area including the sky of the projected picture may be positioned at the bottom center of the projected picture. The train rail may have the largest movement, and thus, an area including the train rail may be the sum of motion vectors among areas of the projected picture, i.e., an area having the largest motion information. Therefore, rotation parameters that enable a region including a train rail to be positioned at the center of the projected picture may be applied. Further, the sky may have the least motion, and thus, the region including the sky may be the sum of motion vectors among regions of the projected picture, i.e., a region having the smallest motion information. Accordingly, rotation parameters that enable an area including the sky to be positioned at the bottom center of the projected picture may be applied

When rotation parameters of the 360-degree video are derived, information about the rotation parameters may be signaled through a picture parameter set (PPS) or a slice header. For example, information about the rotation parameters may be represented as the following table.

TABLE 1

| | Descriptor |
|---|---|
| pic_parameter_set_rbsp( ) { | |
| ... | |
| global_rotation_enabled_flag | u(1) |
| if (global_rotation_enabled_flag) { | u(1) |

| | |
|---|---|
| global_rotation_yaw | se(v) |
| global_rotation_pitch | se(v) |
| global_rotation_roll | se(v) |

}

...

}

Here, a global_rotation_enabled_flag represents a flag indicating whether a global rotation, i.e., a 360-degree video on the spherical surface is rotated, a global_rotation_yaw represents a rotation angle of a yaw axis of the 360-degree video, i.e., a syntax indicating a specific yaw value, a global_rotation_pitch represents a rotation angle of a pitch axis of the 360-degree video, i.e., a syntax indicating a specific pitch value, and a global_rotation_roll represents a rotation angle of a roll axis of the 360-degree video, i.e., a syntax indicating a specific roll value. For example, when a value of the global_rotation_enabled_flag is 1, the 360-degree video may be projected to a 2D picture by applying the global rotation, and when a value of the global_rotation_enabled_flag is not 1, the global rotation may not be applied to the 360-degree video, and the 360-degree video may be projected onto a 2D picture based on the existing projection type. That is, when a value of the global_rotation_enabled_flag is 1, the 360-degree video may be projected onto a 2D picture around a specific position moved by the specific pitch value, the specific yaw value, and the specific roll value at the center point instead of being projected around the center point on the spherical surface, and when a value of the global_rotation_enabled_flag is not 1, the 360-degree video may be projected onto a 2D picture around the center point on the spherical surface.

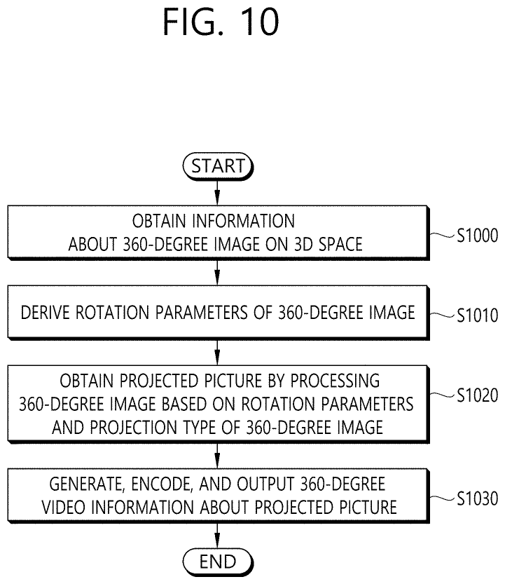

FIG. 10 schematically illustrates a video encoding method by an encoding device according to the present disclosure. The method disclosed in FIG. 10 may be performed by the encoding device disclosed in FIG. 3. Specifically, for example, S1000 to S1010 of FIG. 10 may be performed by a projection processor of the encoding device, S1020 to S1040 may be performed by a quantizer of the encoding device, S1050 may be performed by a quantizer and a predictor of the encoding device, and S1060 may be performed by an entropy encoder of the encoding device.

The encoding device obtains information about a 360-degree image on a 3D space (S1000). The encoding device may obtain information about a 360-degree image captured by at least one camera. The 360-degree image may be a video captured by at least one camera.

The encoding device derives rotation parameters of the 360-degree image (S1010). The encoding device may derive specific yaw values, specific pitch values, and specific roll values that enable a CTU having the smallest motion information to be positioned as close as possible to the center of the bottom of the projected picture as the rotation parameters while a CTU having the largest motion information among coding tree units (CTUs) of non intra pictures among group of pictures (GOP) of the 360-degree image is positioned at the center of the projected picture. That is, the rotation parameters may derive as specific yaw values, specific pitch values, and specific roll values that enable a CTU having the smallest motion information to be positioned as close as possible at the center of the bottom of the projected picture while a CTU having the largest motion information among CTUs of non-intra-pictures among the GOP is positioned at the center of the projected picture. Here, the GOP may represent a first GOP of the 360-degree image. Motion information about each of the CTUs may be derived as the sum of motion vectors of coding units (CUs) included in each CTU, may be derived as the number of CUs included in each CTU and in which inter prediction has been performed, or may be derived as the number of motion vectors of CUs included in each CTU. The encoding device may generate information indicating the rotation parameters. That is, the encoding device may generate information indicating the specific yaw value, information indicating the specific pitch value, and information indicating the specific roll value. Further, the encoding device may generate a flag indicating whether a 360-degree image is rotated on the 3D space. For example, when a value of the flag is 1, 360-degree video information about a projected picture may include information indicating the rotation parameters, and when a value of the flag is not 1, the 360-degree video information may not include information indicating the rotation parameters.

The encoding device obtains a projected picture by processing the 360-degree image based on the rotation parameters and the projection type of the 360-degree image (S1020). The encoding device may project the 360-degree image on a 3D space (3D projection structure) onto a 2D image (or picture) based on the projection type and the rotation parameters of the 360-degree image, and obtain a projected picture. Here, the projection type may be the equirectangular projection (ERP), and the 3D space may be a spherical surface. Specifically, the encoding device may derive a rotated 360-degree image based on the 360-degree image and the rotation parameters on the 3D space, and derive the projected picture by projecting the 360-degree image onto a 2D picture so that a specific position, which is the center of the rotated 360-degree image is mapped to the center point of the projected picture. In other words, the 360-degree image on the 3D space may be projected so that a specific position on the 3D space derived based on the rotation parameters is mapped to the center of the projected picture. Here, the rotation parameters may include a specific pitch value, a specific yaw value, and a specific roll value, and the specific position may be a position in which a yaw component is the specific yaw value and in which a pitch component is the specific pitch value and in which a roll component is the specific roll value on the 3D space. That is, the specific position may be a position moved by the rotation parameters at the center point on the 3D space. Alternatively, the 360-degree image may be projected around a center point on the 3D space to derive the projected picture, and the 360-degree image in the projected picture may be rotated based on the rotation parameters.

Further, the encoding device may perform a projection of a 2D image (or picture) according to a projection type of the 360-degree image among various projection types, and obtain a projected picture. The projection type may correspond to the above-described projection method, and the projected picture may be referred to as a projected frame. The various projection types may include an equirectangular projection (ERP), a cube map projection (CMP), an icosahedral projection (ISP), an octahedron projection (OHP), a truncated square pyramid projection (TSP), a segmented sphere projection (SSP), and an equal area projection (EAP). The 360-degree image may be mapped to faces of a 3D projection structure of each projection type, and the faces may be projected to the projected picture. That is, the projected picture may include faces of a 3D projection structure of each projection type. For example, the 360-degree image may be projected onto the projected picture based on a cube map projection (CMP), and in this case, the 3D projection structure may be a cube. In this case, the 360-degree image may be mapped to six faces of the cube, and the faces may be projected to the projected picture. As another example, the 360-degree image may be projected onto the projected picture based on an icosahedral projection (ISP), and in this case, the 3D projection structure may be an icosahedron. As another example, the 360-degree image may be projected onto the projected picture based on an octahedron projection (OHP), and in this case, the 3D projection structure may be an octahedron. Further, the encoding device may perform processing such as rotating or rearranging each of faces of the projected picture, or changing a resolution of each face.

The encoding device generates, encodes, and outputs 360-degree video information about the projected picture (S1030). The encoding device may generate the 360-degree video information about the projected picture, and encode the 360-degree video information to output the 360-degree video information through a bitstream, and the bitstream may be transmitted through a network or may be stored in a non-transitory computer readable medium.

Further, the 360-degree video information may include information indicating a projection type of the projected picture. The projection type of the projected picture may be one of several projection types, and the various projection types may include the above-described equirectangular projection (ERP), cube map projection (CMP), icosahedral Projection (ISP), octahedron projection (OHP), truncated square pyramid projection (TSP), segmented sphere projection (SSP), and equal area projection (EAP).

Further, the 360-degree video information may include information indicating the rotation parameters. That is, the 360-degree video information may include information indicating the specific yaw value, information indicating the specific pitch value, and information indicating the specific roll value. Further, the 360-degree video information may generate a flag indicating whether a 360-degree image is rotated on the 3D space. For example, when a value of the flag is 1, the 360-degree video information may include information indicating the rotation parameters, and when a value of the flag is not 1, the 360-degree video information may not include information indicating the rotation parameter. The information indicating the rotation parameters and the flag may be derived as illustrated in Table 1. Further, the information indicating the rotation parameters and/or the flag may be signaled through a picture parameter set (PPS) or a slice header. That is, the information indicating the specific yaw value, the information indicating the specific pitch value, the information indicating the specific roll value, and/or the flag may be signaled through a picture parameter set (PPS) or a slice header.

Although not illustrated in the drawing, when decoding is performed for the projected picture, the encoding device may derive a prediction sample of the projected picture, and generate residual samples based on an original sample and the derived prediction sample. The encoding device may generate information about the residual based on the residual sample. The information about the residual may include transform coefficients on the residual sample. The encoding device may derive the reconstructed sample based on the predicted sample and the residual sample. That is, the encoding device may derive the reconstructed sample by adding the prediction sample and the residual sample. Further, the encoding device may encode information about the residual and output the encoded information in a bitstream format. The bitstream may be transmitted to the decoding device through a network or a storage medium.

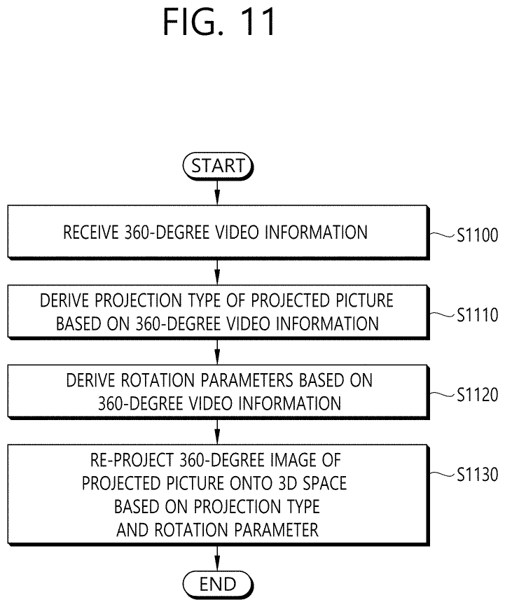

FIG. 11 schematically illustrates a video decoding method by a decoding device according to the present disclosure. The method disclosed in FIG. 11 may be performed by the decoding device disclosed in FIG. 4. Specifically, for example, S1100 to S1120 of FIG. 11 may be performed by an entropy decoder of the decoding device, and S1130 may be performed by a re-projection processor of the decoding device.

The decoding device receives 360-degree video information (S1100). The decoding device may receive the 360-degree video information through a bitstream.

The 360-degree video information may include projection type information indicating the projection type of the projected picture. The projection type of the projected picture may be derived based on the projection type information. Here, the projection types may be one of the above-described equirectangular projection (ERP), cube map projection (CMP), icosahedral projection (ISP), octahedron projection (OHP), truncated square pyramid projection (TSP), segmented sphere projection (SSP), and equal area projection (EAP). That is, the projection type of the projected picture may be one of several projection types, and the several projection types may include the above-described equirectangular projection (ERP), cube map projection (CMP), icosahedral projection (ISP), octahedron projection (OHP), truncated square pyramid projection (TSP), segmented sphere projection (SSP), and equal area projection (EAP).

Further, the 360-degree video information may include information indicating the rotation parameters. That is, the 360-degree video information may include information indicating the specific yaw value, information indicating the specific pitch value, and information indicating the specific roll value. Further, the 360-degree video information may include a flag indicating whether a 360-degree image on the 3D space is rotated. For example, when a value of the flag is 1, the 360-degree video information may include information indicating the rotation parameters, and when a value of the flag is not 1, the 360-degree video information may not include information indicating the rotation parameter. The information indicating the rotation parameters and the flag may be derived as illustrated in Table 1. Further, the information indicating the rotation parameters and/or the flag may be signaled through a picture parameter set (PPS) or a slice header. That is, the information indicating the specific yaw value, the information indicating the specific pitch value, the information indicating the specific roll value, and/or the flag may be received through a picture parameter set (PPS) or a slice header.

The decoding device derives a projection type of a projected picture based on the 360-degree video information (S1110). The 360-degree video information may include projection type information indicating a projection type of the projected picture, and the projection type of the projected picture may be derived based on the projection type information. Here, the projection types may be one of an equirectangular projection (ERP), a cube map projection (CMP), an icosahedral projection (ISP), an octahedron projection (OHP), a truncated square pyramid projection (TSP), a segmented sphere projection (SSP), and an equal area projection (EAP).

The 360-degree image may be mapped to faces of a 3D projection structure of each projection type, and the faces may be projected onto the projected picture. That is, the projected picture may include faces of a 3D projection structure of each projection type. For example, the projected picture may be a picture in which the 360-degree image is projected based on the CMP. In this case, the 360-degree image may be mapped to six faces of a cube, which is a 3D projection structure of the CMP, and the faces may be projected onto the projected picture. As another example, the projected picture may be a picture in which the 360-degree image is projected based on the ISP. In this case, the 360-degree image may be mapped to 20 faces of an icosahedron, which is a 3D projection structure of the ISP, and the faces may be projected onto the projected picture. As another example, the projected picture may be a picture in which the 360-degree image is projected based on the OHP. In this case, the 360-degree image may be mapped to eight faces of an icosahedron, which is a 3D projection structure of the OHP, and the faces may be projected onto the projected picture.

The decoding device derives rotation parameters based on the 360-degree video information (S1120). The decoding device may derive the rotation parameters based on the 360-degree video information, and the rotation parameters may include a specific yaw value, a specific pitch value, and a specific roll value of a specific position on the 3D space of the 360-degree image of the projected picture. Further, the 360-degree video information may include information indicating the specific yaw value, information indicating the specific pitch value, and information indicating the specific roll value. The decoding device may derive a specific yaw value, a specific pitch value, and a specific roll value of the specific position on the 3D space of the 360-degree image based on information representing the specific yaw value, information representing the specific pitch value, and information representing the specific roll value. The rotation parameters may be derived as a specific yaw value, a specific pitch value, and a specific roll value that enable a CTU having the smallest motion information to be positioned as close as possible to the center of the bottom of the projected picture while a CTU having the largest motion information among coding tree units (CTUs) of non intra pictures among group of pictures (GOP) of a 360-degree image is positioned at the center of the projected picture. Here, the GOP may represent a first GOP of the 360-degree image. Further, motion information about each of the CTUs may be derived as the sum of motion vectors of coding units (CUs) included in each CTU, may be derived as the number of CUs included in each CTU and in which inter prediction has been performed, or may be derived as the number of motion vectors of CUs included in each CTU.

The decoding device re-projects a 360-degree image of the projected picture onto a 3D space based on the projection type and the rotation parameters (S1130). The decoding device may re-project the 360-degree image of the projected picture onto a 3D space (3D projection structure) based on the projection type and the rotation parameters. Here, the projection type may be an equirectangular projection (ERP), and the 3D space may be a spherical surface. Specifically, the decoding device may re-project the 360-degree image so that the center of the projected picture is mapped to a specific position on the 3D space (3D projection structure). In other words, the 360-degree image of the projected picture may be re-projected so that the center of the projected picture is mapped to a specific position on the 3D space derived based on the rotation parameters. Here, the rotation parameters may include a specific pitch value, a specific yaw value, and a specific roll value, and the specific position may be derived as a position in which a yaw component is the specific yaw value and in which a pitch component is the specific pitch value and in which a roll component is the specific roll value on the 3D space. Alternatively, the 360-degree image included in the projected picture may be rotated, and the rotated 360-degree image may be re-projected so that the center of the projected picture is mapped to the center point on the 3D space.

The 360-degree video information may include a flag indicating whether a 360-degree image on the 3D space is rotated. For example, when a value of the flag is 1, the 360-degree video information may include information indicating the rotation parameters, and when a value of the flag is not 1, the 360-degree video information may not include information indicating the rotation parameter. The information indicating the rotation parameters and the flag may be derived as in Table 1. Further, when a value of the flag is not 1, the center of the projected picture may be re-projected to be mapped to the center point on the 3D space, and the center point on the 3D space may be a position in which a yaw component, a pitch component, and a roll component are 0.

Although not illustrated in the drawing, the decoding device may generate prediction samples by performing prediction on the projected picture. Further, when there are not residual samples of the projected picture, the decoding device may derive the prediction samples as reconstructed samples of the projected picture, and when there are residual samples of the projected picture, the decoding device may generate reconstruction samples of the projected picture by adding residual samples to the prediction samples.

Although not illustrated in the drawing, when there are residual samples of the projected picture, the decoding device may receive information about the residual of each quantization processing unit. The residual information may include a transform coefficient of the residual sample. The decoding device may derive the residual sample (or residual sample array) of the target block based on the residual information. The decoding device may generate a reconstructed sample based on the predicted sample and the residual sample, and derive a reconstructed block or a reconstructed picture based on the reconstructed sample. Thereafter, the decoding device may apply an in-loop filtering procedure, such as a deblocking filtering and/or SAO procedure to the reconstructed picture in order to improve a subjective/objective image quality, as needed, as described above.

According to the present disclosure, described above, by projecting a rotated 360-degree image based on rotation parameters, a projected picture may be derived in which a region with a lot of motion information is positioned at the center and in which a region with little motion information is positioned at the bottom center and thus occurrence of artifacts due to discontinuity of the projected picture can be reduced, and overall coding efficiency can be improved.

Further, according to the present disclosure, by projecting a rotated 360-degree image based on rotation parameters, a projected picture may be derived in which a region with a lot of motion information is positioned at the center and in which a region with little motion information is positioned at the bottom center and thus distortion of the moving object can be reduced, and overall coding efficiency can be improved.

In the above-described embodiment, the methods are described based on the flowchart having a series of steps or blocks. The present disclosure is not limited to the order of the above steps or blocks. Some steps or blocks may occur simultaneously or in a different order from other steps or blocks as described above. Further, those skilled in the art will understand that the steps shown in the above flowchart are not exclusive, that further steps may be included, or that one or more steps in the flowchart may be deleted without affecting the scope of the present disclosure.

The method according to the present disclosure described above may be implemented in software. The encoding device and/or decoding device according to the present disclosure may be included in a device that performs image processing, for example, for a TV, a computer, a smart phone, a set-top box, or a display device.

When the embodiments of the present disclosure are implemented in software, the above-described method may be implemented by modules (processes, functions, and so on) that perform the functions described above. Such modules may be stored in memory and executed by a processor. The memory may be internal or external to the processor, and the memory may be coupled to the processor using various well known means. The processor may comprise an application-specific integrated circuit (ASIC), other chipsets, a logic circuit and/or a data processing device. The memory may include a read-only memory (ROM), a random access memory (RAM), a flash memory, a memory card, a storage medium, and/or other storage device.

What is claimed is:

1. A method of encoding a video performed by an encoding device, the method comprising:
obtaining information about a 360-degree image on a 3D space;
deriving rotation parameters of the 360-degree image;
obtaining a projected picture by processing the 360-degree image based on the rotation parameters and a projection type of the 360-degree image; and
generating, encoding, and outputting 360-degree video information about the projected picture,
wherein the projection type is an equirectangular projection (ERP), and
the 360-degree image on the 3D space is projected so that a specific position on the 3D space derived based on the rotation parameters is mapped to a center of the projected picture.

2. The method of claim 1, wherein the obtaining of a projected picture comprises:
deriving a rotated 360-degree image based on the 360-degree image and the rotation parameters; and
deriving the projected picture by projecting the 360-degree image onto a 2D picture so that a specific position, which is a center of the rotated 360-degree image is mapped to the center of the projected picture.

3. The method of claim 1, wherein the rotation parameters are derived as a specific yaw value, a specific pitch value, and a specific roll value that enable a coding tree unit (CTU) having the smallest motion information to be positioned as close as possible to a center of the bottom of a picture while a CTU having the largest motion information among CTUs of non intra pictures among group of pictures (GOP) is positioned at a center of the picture.

4. The method of claim 3, wherein motion information about each of the CTUs is derived as the sum of motion vectors of coding units (CUs) included in each CTU.

5. The method of claim 3, wherein the 360-degree video information comprises information indicating the specific yaw value, information indicating the specific pitch value, and information indicating the specific roll value.

6. The method of claim 3, wherein the specific position is a position in which a yaw component is the specific yaw value and in which a pitch component is the specific pitch value and in which a roll component is the specific roll value on the 3D space.

7. The method of claim 1, wherein the 360-degree video information comprises a flag indicating whether a 360-degree image on the 3D space is rotated,
the 360-degree video information comprises information indicating the rotation parameters, when a value of the flag is 1, and
the 360-degree video information does not comprise information indicating the rotation parameters, when a value of the flag is not 1.

8. A method of decoding a video performed by a decoding device, the method comprising:
receiving 360-degree video information;
deriving a projection type of a projected picture based on the 360-degree video information;
deriving rotation parameters based on the 360-degree video information; and
re-projecting a 360-degree image of the projected picture onto a 3D space based on the projection type and the rotation parameters,
wherein the projection type is an equirectangular projection (ERP), and
the 360-degree image of the projected picture is re-projected so that a center of the projected picture is mapped to a specific position on the 3D space derived based on the rotation parameters.

9. The method of claim 8, wherein the rotation parameters comprise a specific yaw value, a specific pitch value, and a specific roll value of the specific position on the 3D space, and
the 360-degree video information comprises information indicating the specific yaw value, information indicating the specific pitch value, and information indicating the specific roll value.

10. The method of claim 9, wherein the specific position is derived as a position in which a yaw component is the specific yaw value and in which a pitch component is the specific pitch value, and in which a roll component is the specific roll value on the 3D space.

11. The method of claim 8, wherein the rotation parameters are derived as a specific yaw value, a specific pitch value, and a specific roll value that enable a coding tree unit (CTU) having the smallest motion information to be positioned as close as possible to a center of the bottom of a picture while a CTU having the largest motion information among CTUs of non intra pictures among group of pictures (GOP) is positioned at a center of the picture.

12. The method of claim 11, wherein motion information about each of the CTUs is derived as the sum of motion vectors of coding units (CUs) included in each CTU.

13. The method of claim 8, wherein the 360-degree video information comprises a flag indicating whether a 360-degree image on the 3D space is rotated,
the 360-degree video information comprises information indicating the rotation parameters, when a value of the flag is 1, and
the 360-degree video information does not comprise information indicating the rotation parameters, when a value of the flag is not 1.

14. The method of claim 8, wherein the center of the projected picture is re-projected to be mapped to a center point on the 3D space, when a value of the flag is not 1, and
the center point on the 3D space is a position in which a yaw component, a pitch component, and a roll component are 0.

15. A decoding device for decoding an image, the decoding device comprising:
an entropy decoder configured to receive 360-degree video information, to derive a projection type of a projected picture based on the 360-degree video information, and to derive rotation parameters based on the 360-degree video information; and
a re-projection processor configured to re-project a 360-degree image of the projected picture onto a 3D space based on the projection type and the rotation parameters,
wherein the projection type is an equirectangular projection (ERP), and
the 360-degree image of the projected picture is re-projected so that a center of the projected picture is mapped to a specific position on the 3D space derived based on the rotation parameters.
